(19) United States
(12) Patent Application Publication
(10) Pub. No.: US 2015/0288243 A1
(43) Pub. Date: Oct. 8, 2015

(54) SPINDLE MOTOR AND ASSEMBLING METHOD OF SLEEVE AND BASE IN THE SAME

(71) Applicant: Samsung Electro-Mechanics Co., Ltd., Suwon-Si (KR)

(72) Inventors: Yeong Hwan SONG, Gyeonggi-Do (KR); Woo Jin LEE, Gyeonggi-Do (KR); Sang Min BAEK, Gyeonggi-Do (KR); Hyun Jung LEE, Gyeonggi-Do (KR)

(73) Assignee: Samsung Electro-Mechanics Co., Ltd., Suwon-Si (KR)

(21) Appl. No.: 14/676,894

(22) Filed: Apr. 2, 2015

(30) Foreign Application Priority Data
Apr. 3, 2014 (KR) 10-2014-0039939

(51) Int. Cl. H02K 5/167; H02K 15/14; B32B 37/18; B32B 38/00; B32B 37/14; B32B 37/12

(52) U.S. Cl. CPC H02K 5/1675; B32B 37/142; B32B 37/1284; B32B 37/18; B32B 38/0004; B32B 38/0008; H02K 15/14; B32B 2037/1253; B32B 2457/00

(57) ABSTRACT

There are provided a spindle motor and an assembling method of a sleeve and a base in the same. The spindle motor includes: a shaft; a sleeve formed in a hollow cylindrical shape so as to rotatably support the shaft and having a plated layer coated on an outer peripheral surface thereof; and a base including a support part having a hollow part formed at the center thereof so that the sleeve is inserted thereinto and fixed thereto and coated with a plated layer, wherein an inner peripheral surface of the base and an outer peripheral surface of the sleeve are bonded to each other by an adhesive.

### CROSS-REFERENCE TO RELATED APPLICATION

This application claims the benefit of Korean Patent Application No. 10-2014-0039939, filed on Apr. 3, 2014, entitled “Spindle Motor and Assembling Method of Sleeve and Base in the Same” which is hereby incorporated by reference in its entirety into this application.

### BACKGROUND

The present disclosure relates to a spindle motor and an assembling method of a sleeve and a base in the same.

A spindle motor has been widely used as a driving unit of a hard disk drive (HDD), an optical disk drive (ODD), and other recording media requiring high speed rotation.

That is, the spindle motor, which is a device rotating a disk so that data written in the disk may be read using a head, generates a magnetic field when a current is applied to a core. This magnetic field provides magnetic force to a magnet provided in a rotor. Then, a motor rotates by an operation principle of rotating the rotor through the magnetic force.

An example of the spindle motor has been disclosed in Korean Patent Laid-Open Publication No. 10-2010-0135015 (entitled “Motor”). The spindle motor disclosed in Patent Document 1 is configured to include a rotor, a shaft, a sleeve, a stator, and a base, as well-known.

The base, which is a space capable of accommodating members configuring the spindle motor therein, includes a cylindrical support part formed at the center thereof. A sleeve is inserted into and fixed to a hollow part formed at the center of the support part. That is, an inner peripheral surface of the support part supports an outer peripheral surface of the sleeve.

The stator, which is a fixed structure including a core having a ring shape and a coil wound around the core and generating a magnetic field, is supported by the base.

The sleeve may be formed in a cylindrical shape so as to rotatably support the shaft disposed therein, and may be, for example, a hydrodynamic bearing.

In addition, the rotor includes a hub and a skirt part having a magnet mounted thereon and is a rotating structure rotatably provided with respect to the stator.

The shaft, which supports the hub in an axial direction at the time of rotation of the spindle motor, is coupled to the center of the rotor and is rotatably supported by the sleeve.

In this spindle motor, the sleeve is inserted into the hollow part formed in the support part of the base, such that positions of the base and the sleeve are fixed. In the spindle motor, an adhesive is applied to a distal end portion at which a lower end of the base, more specifically, a lower end of the support part and a lower end of the sleeve contact each other in order to provide sealing as well as fix the positions of the base and the sleeve.

However, in the spindle motor according to the related art, in the case in which the adhesive is irregularly applied in a process of adhering the base and the sleeve to each other, the base and the sleeve are not appropriately adhered to each other, such that a defect may occur. Other methods that may solve this problem should be devised.

### RELATED ART DOCUMENT

[Patent Document]

(Patent Document 1) Korean Patent Laid-Open Publication No. 10-2010-0135015

### SUMMARY

An aspect of the present disclosure may provide a spindle motor capable of securing assembling force between a base and a sleeve of the spindle motor by improving interface bonding force in an adhesive applied between the base and the sleeve, and an assembling method of a sleeve and a base in the same.

According to an aspect of the present disclosure, a spindle motor may include: a shaft; a sleeve formed in a hollow cylindrical shape so as to rotatably support the shaft and having a plated layer coated on an outer peripheral surface thereof; and a base including a support part having a hollow part formed at the center thereof so that the sleeve is inserted thereinto and fixed thereto and coated with a plated layer, wherein an inner peripheral surface of the base and an outer peripheral surface of the sleeve are bonded to each other by an adhesive.

The plated layer of the sleeve and the plated layer of the base may be Ni plated layers.

The plated layer of the sleeve may have pattern forming grooves formed therein.

The pattern forming grooves may be formed along the outer peripheral surface of the sleeve.

The plated layer of the support part of the base may have pattern forming grooves formed therein.

The pattern forming grooves may be formed along an inner peripheral surface of the support part of the base.

The pattern forming grooves of the sleeve and the pattern forming grooves of the support part may be disposed at the same height to thereby face each other.

According to another aspect of the present disclosure, an assembling method of a sleeve and a base in a spindle motor may include: providing a base coated with a plated layer; forming pattern forming grooves in the plated layer on a support part of the base; providing a sleeve coated with a plated layer; forming pattern forming grooves in a plated layer on an outer peripheral surface of the sleeve; supplying an adhesive; inserting the sleeve into the support part of the base; and hardening the adhesive.

The pattern forming grooves of the base may be formed by peeling off portions of the plated layer of the support part of the base through laser irradiation.

The pattern forming grooves of the base may be formed at arithmetic average roughness of 1.5 or less in the plated layer.

A depth of the pattern forming groove of the base may be set to a value within a range between ½ of a thickness of the plated layer before being processed and 1.1 times the thickness of the plated layer.

The pattern forming grooves of the sleeve may be formed by peeling off portions of the plated layer of the sleeve through laser irradiation.

The pattern forming grooves of the sleeve may be formed at arithmetic average roughness of 1.5 or less in the plated layer.

A depth of the pattern forming groove of the sleeve may be set to a value within a range between ½ of a thickness of the plated layer before being processed and 1.1 times the thickness of the plated layer.

The pattern forming grooves of the support part of the base and the pattern forming grooves of the sleeve may be disposed so as to face each other.

The pattern forming grooves of the support part of the base may be formed along an inner peripheral surface of the support part, and the pattern forming grooves of the sleeve may be formed along the outer peripheral surface of the sleeve.

The spindle motor may include: a shaft; a sleeve formed in a hollow cylindrical shape so as to rotatably support the shaft and having a plated layer coated on an outer peripheral surface thereof; and a base including a support part having a hollow part formed at the center thereof so that the sleeve is inserted thereinto and fixed thereto and coated with a plated layer.

The adhesive may be a conductive adhesive.

### BRIEF DESCRIPTION OF DRAWINGS

The above and other aspects, features and other advantages of the present disclosure will be more clearly understood from the following detailed description taken in conjunction with the accompanying drawings, in which:

FIG. 1 is a schematic cross-sectional view of a spindle motor according to an exemplary embodiment of the present disclosure;

FIG. 2 is a perspective view of a sleeve shown in FIG. 1;

FIG. 3 is a partially enlarged view of part A of the spindle motor shown in FIG. 1;

FIG. 4 is a partially enlarged view of part A of a spindle motor according to another example;

FIG. 5 is a graph showing bonding strength between a base and a sleeve; and

FIG. 6 is a flow chart showing an assembling method of a sleeve and a base.

### DETAILED DESCRIPTION

The objects, features and advantages of the present disclosure will be more clearly understood from the following detailed description of the exemplary embodiments taken in conjunction with the accompanying drawings. Throughout the accompanying drawings, the same reference numerals are used to designate the same or similar components, and redundant descriptions thereof are omitted. Further, in the following description, the terms “first,” “second,” “one side,” “the other side” and the like are used to differentiate a certain component from other components, but the configuration of such components should not be construed to be limited by the terms. Further, in the description of the present disclosure, when it is determined that the detailed description of the related art would obscure the gist of the present disclosure, the description thereof will be omitted.

Hereinafter, exemplary embodiments of the present disclosure will be described in detail with reference to the accompanying drawings.

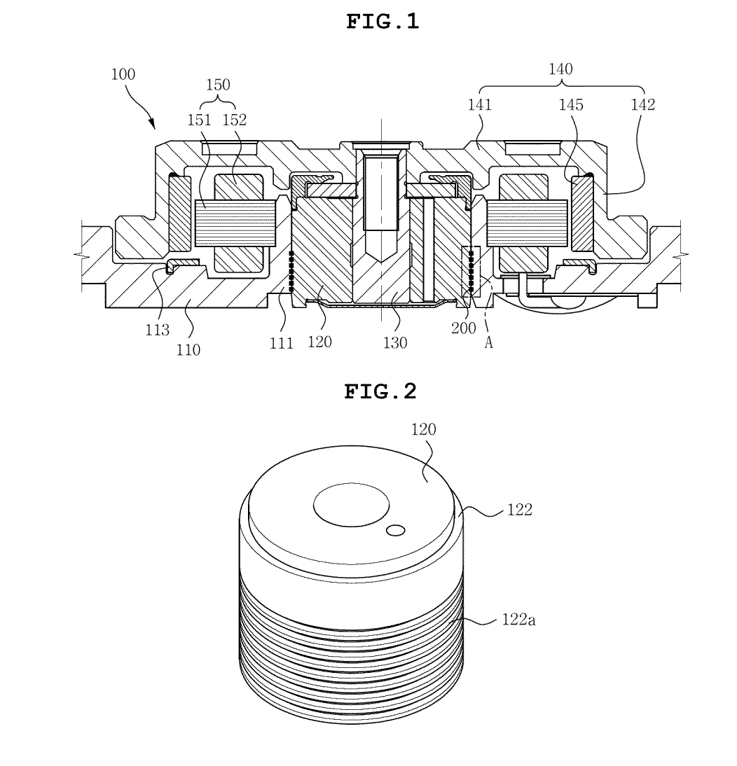

Referring to FIGS. 1 and 2, a spindle motor 100 according to an exemplary embodiment of the present disclosure is configured to include a base 110, a sleeve 120, a shaft 130, a rotor 140, and a stator 150. Particularly, in the spindle motor 100 according to the exemplary embodiment of the present disclosure, an adhesive 200 may be interposed between an outer peripheral surface of the sleeve 120 and an inner peripheral surface of the base 110 to improve interface assuming force therebetween.

The base 110, which is installed in a device such as a hard disk drive (not shown), or the like, provides a space capable of accommodating members configuring the spindle motor therein. As shown, the base 110 includes a cylindrical support part 111 formed at the center thereof, and a sleeve 120 to be described below is inserted into and bonded to a hollow part formed at the center of the support part 111.

In addition, the base 110 includes a pulling plate 113 attached to an upper surface thereof, wherein the pulling plate 113 is made of a magnetic material. Preferably, the pulling plate 113 is disposed at a portion adjacent to a magnet 145 to be described below, such that attractive force by magnetic force acts between the pulling plate 113 and the magnet 145.

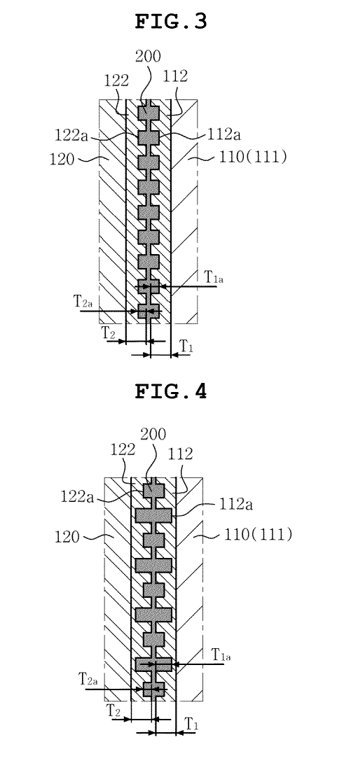

The base 110 is coated with a plated layer 112 (See FIG. 3) in order to improve corrosion resistance and abrasion resistance. Portions of the plated layer 112 are peeled off in the plated layer 112 using laser, or the like, to form pattern forming grooves 112a. Particularly, the pattern forming grooves 112a are formed along an inner peripheral surface of the support part 110 of the base 110, as shown in FIG. 3.

The sleeve 120 may be inserted and assembled into the support part 111 of the base 110, as described above. In addition, the sleeve 120 may be generally formed in a cylindrical shape to rotatably support the shaft 130 therein.

The sleeve 120 includes a hydrodynamic bearing formed in an inner peripheral surface thereof spaced apart from the shaft 130 by a predetermined interval and a bearing surface thereof contacting a thrust plate (that does not have a reference numeral).

Particularly, the sleeve 120 according to the exemplary embodiment of the present disclosure may also have a plated layer 122 (See FIG. 3) coated on an outer peripheral surface thereof to improve corrosion resistance and abrasion resistance. The plated layer 122 coated on the sleeve 120 has been shown only on the outer peripheral surface of the sleeve 120 facing the support part 111 of the base 110.

Portions of the plated layer 122 are peeled off in the plated layer 122 using laser, or the like, to form pattern forming grooves 122a. Particularly, the pattern forming grooves 122a are formed along an outer peripheral surface of the sleeve 120, as shown in FIG. 2. The pattern forming grooves 122a of the sleeve 120 are disposed so as to face the pattern forming grooves 112a of the base 110, such that a bonding cross-sectional area between the base 110 and the sleeve 120 is increased at the time of bonding between the base 110 and the sleeve 120, thereby making it possible to improve shearing stress.

The shaft 130 supports a hub 141 in an axial direction, is inserted into the sleeve 120 to thereby be rotatably supported by the sleeve 120, and has a thrust plate disposed at an upper side portion thereof.

In other words, it is preferable that the shaft 130 is spaced apart from the inner peripheral surface of the sleeve 120 by a predetermined interval, such that it is maintained in a state in which it does not contact the inner peripheral surface of the sleeve 120, in order to decrease contact friction with the inner peripheral surface of the sleeve 120. In addition, a clearance between the sleeve 120 and the shaft 130 may be filled with a fluid, for example, oil, and friction between the sleeve 120 and the shaft 130 at the time of rotation of the shaft 130 may be decreased through the oil.

Further, the rotor 140 having a cup shape includes the hub 141 and a skirt part 142 having the magnet 145 mounted thereon, and the shaft 130 is disposed on a line of a vertical axis coinciding with the center of rotation of the hub 141.

The rotor 140, which is a rotating structure provided to form an electric field for rotating the hub 141 to thereby be rotatable with respect to the stator 150, includes the magnet 145 disposed on an inner peripheral surface of the skirt part 142 and having the ring shape, wherein the magnet 145 is disposed so as to face a core 151, having a predetermined interval therebetween, and forms a magnetic field to generate electromagnetic force together with an electric field formed in a coil 152. The rotor 140 of the spindle motor 100 rotates through the electromagnetic force.

The stator 150 is a fixed structure including the core 151 fixedly disposed above the base 110 and having a ring shape and the coil 152 wound around the core 151 to generate the electric field.

FIG. 3, which is a partially enlarged view of a part of the spindle motor shown in FIG. 1, shows an assembled state between the base 110 and the sleeve 120.

In the exemplary embodiment of the present disclosure, the adhesive 200 is interposed between the inner peripheral surface of the support part 111 of the base 110 and the outer peripheral surface of the sleeve 120 to assemble the base 110 and the sleeve 120 to each other. Alternatively, a conductive adhesive may also be applied as the adhesive 200 so as to maintain conductive connection between the base 110 and the sleeve 120.

As described above, the outer peripheral surface of the sleeve 120 is coated with the plated layer 122. The plated layer 122 is patterned in a rugged shape by forming a plurality of pattern forming grooves 122a at a predetermined depth along the outer peripheral surface of the sleeve 120. The pattern forming grooves 122a are formed by irradiating laser, for example, Nd-YAG laser to a surface of the plated layer 122 to peel off portions of the plated layer 122. Surface roughness is provided in this pattern shape to the plated layer.

Correspondingly, the plated layer 112 is coated onto the support part 111 of the base 110 facing the outer peripheral surface of the sleeve 120. The plated layer 112 is patterned in a rugged shape by forming a plurality of pattern forming grooves 112a at a predetermined depth along the inner peripheral surface of the support part 111. The pattern forming grooves 112a of the base 110 are formed by irradiating laser to a surface of the plated layer 112 to peel off portions of the plated layer 112. Surface roughness is provided in this pattern shape to the plated layer.

Preferably, the plated layers 122 and 112 each coated on the outer peripheral surface of the sleeve 120 and the inner peripheral surface of the support part 111 of the base 110 are nickel (Ni) plated layers.

As shown, in the exemplary embodiment of the present disclosure, the bonding cross-sectional area is increased through the pattern forming grooves 112a of the support part 111 of the base 110 and the pattern forming grooves 122a of the sleeve 120.

As well known, an anchor effect that assembling force between the base 110 and the sleeve 120, which are adhered members, through the adhesive 200 is increased by penetrating and sticking the adhesive 200 into and onto holes or concave grooves formed in surfaces of the adhered members may be expected.

Alternatively, in the exemplary embodiment of the present disclosure, it is preferable that the plated layer 112 of the base 110 and the plated layer 122 of the sleeve 120 are spaced apart from each other, such that they are maintained in a state in which they do not contact each other, in order not to be scratched or pressed. In other words, a space part (clearance) is formed between the plated layer 112 of the base 110 and the plated layer 122 of the sleeve 120 and is filled with the adhesive 200. The space part between the base and the sleeve not only protects the plated layer, but also assists in penetration of the adhesive.

FIG. 4 is a partially enlarged view of a spindle motor according to another example and is similar to FIG. 3 except for shapes of the pattern forming grooves 112a and 122a shown in FIG. 3. Therefore, in order to assist in clearly understanding the present disclosure, a description for components that are the same as or similar to the above-mentioned components will be omitted.

In FIG. 4, pattern forming grooves 112a and 122a may have different sizes, respectively, unlike the pattern forming grooves 122a of the sleeve 120 and the pattern forming grooves 112a of the support part 111 of the base 110 shown in FIG. 3.

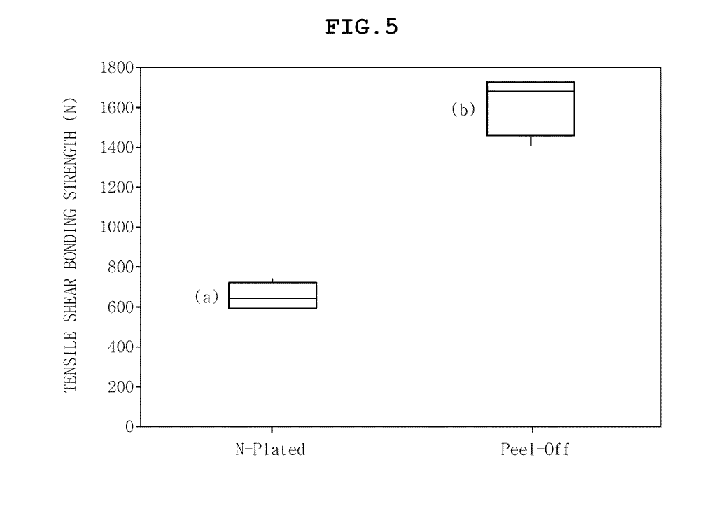

FIG. 5 is a graph showing bonding strength between a base and a sleeve having an adhesive interposed therebetween.

Bonding surfaces between the base 110 and the sleeve 120 are coated with Ni plated layers. The bonding strength between the base 110 and the sleeve 120 coated with the Ni plated layers is measured. In FIG. 5, (a) indicates bonding strength between Ni plated layers on which surface roughness is not formed, while (b) indicates bonding strength between Ni plated layers on which surface roughness is formed by forming pattern forming grooves through laser irradiation.

As shown, (a) indicates tensile shear bonding strength of about 700N between the Ni plated layers that do not include the pattern forming grooves, while (b) indicates tensile shear bonding strength of about 1700N between the Ni plated layers that include the pattern forming grooves formed by peeling off portions of the Ni plated layers through the laser irradiation. That is, it may be confirmed that the bonding strength between the base and the sleeve is further improved by peeling off portions of thicknesses of the Ni plated layer to provide the pattern forming grooves.

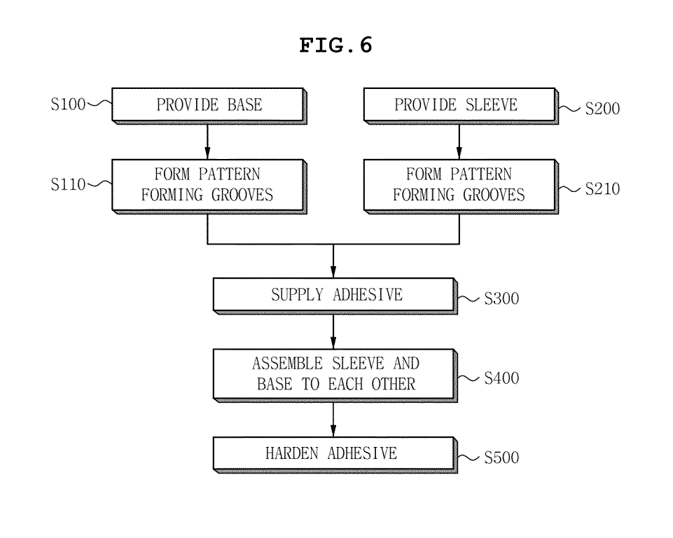

FIG. 6 is a flow chart showing an assembling method of a sleeve and a base according to the exemplary embodiment of the present disclosure.

First, the assembling method of a sleeve and a base according to the exemplary embodiment of the present disclosure includes providing the base 110 enclosed by the plated layer 112 (S100). Preferably, the plated layer 112 is the Ni plated layer.

Then, the assembling method of a sleeve and a base according to the exemplary embodiment of the present disclosure includes forming the pattern forming grooves 112a by irradiating the laser on the inner peripheral surface of the support part 111 of the base 110 facing the sleeve 120 (S110). Here, the laser is the Nd-YAG laser. The pattern forming grooves 112a are formed along the inner peripheral surface of the support part 111.

The pattern forming grooves 112a are formed in the rugged shape so as to provide the surface roughness to the plated layer 112. Preferably, the pattern forming grooves 112a are processed by a laser beam having a wavelength of 213 to 1302 nm that is available from the open market so as to maintain arithmetic average roughness Ra to be 1.5 or less.

In addition, a depth T₁ₐ of the pattern forming groove 112a has a value within a range between ½ of a thickness T₁ of the plated layer 112 before being processed and 1.1 times the thickness T₁ (See FIG. 3). In the case in which the depth of the pattern forming groove 112a is larger than the thickness of the plated layer 112 before being processed, the pattern forming groove 112a penetrates through the plated layer 112 to expose the support part 111 of the base 110, and portions of the plated layer 112 moves to thickness portions to which the laser is not irradiated through the laser irradiation, such that they become thick.

The pattern forming grooves 112a of the plated layer 112 may be peeled off so as not to expose the support part 111 of the base 110 in consideration of corrosion resistance.

In addition, the assembling method of a sleeve and a base according to the exemplary embodiment of the present disclosure includes providing the sleeve 120 enclosed by the plated layer 122 (S200). Preferably, the plated layer 122 is the Ni plated layer.

Then, the assembling method of a sleeve and a base according to the exemplary embodiment of the present disclosure includes forming the pattern forming grooves 122a by irradiating the laser on the outer peripheral surface of the sleeve 120 facing the support part 111 of the base 110 (S210). Here, the laser is the Nd-YAG laser.

The pattern forming grooves 122a are formed in the rugged shape so as to provide the surface roughness to the plated layer 122. Preferably, the pattern forming grooves 122a are processed by a laser beam having a wavelength of 213 to 1302 nm that is available from the open market so as to maintain arithmetic average roughness Ra to be 1.5 or less.

In addition, a depth T₂ₐ of the pattern forming groove 122a has a value within a range between ½ of a thickness T₂ of the plated layer 122 before being processed and 1.1 times the thickness T₂ (See FIG. 3). In the case in which the depth of the pattern forming groove 122a is larger than the thickness of the plated layer 122 before being processed, the pattern forming groove 122a penetrates through the plated layer 122 to expose the sleeve 120, and portions of the plated layer 122 moves to thickness portions to which the laser is not irradiated through the laser irradiation, such that they become thick.

The pattern forming grooves 122a of the plated layer 122 may be peeled off so as not to expose the sleeve 120 in consideration of corrosion resistance.

Then, the assembling method of a sleeve and a base according to the exemplary embodiment of the present disclosure includes supplying the adhesive 200 (S300). The adhesive 200 may be applied onto the plated layer 122 of the sleeve 120 or be applied onto the plated layer 112 of the support part 111 of the base 110 depending on convenience of a worker. The adhesive 200 may be a conductive adhesive.

The assembling method of a sleeve and a base according to the exemplary embodiment of the present disclosure includes inserting the sleeve 120 into the hollow part formed at the center of the support part 111 of the base 110 (S400) after applying the adhesive 200. The sleeve 120 is fitted into the hollow part of the support part 111, such that the adhesive 200 may uniformly penetrate into the pattern forming grooves 112a and 122a. In addition, the adhesive 200 is interposed between the outer peripheral surface of the sleeve and the inner peripheral surface of the support part, thereby making it possible to prevent a direct contact between the plated layer 122 of the sleeve 120 and the plated layer 112 of the support part 111 in advance.

Finally, the assembling method of a sleeve and a base according to the exemplary embodiment of the present disclosure includes hardening the adhesive 200 (S500). In the exemplary embodiment of the present disclosure, the adhesive 200 is hardened after the sleeve 120 and the base 110 are assembled to each other, thereby making it possible to secure a reliable assembled state between two components.

As set forth above, according to the exemplary embodiments of the present disclosure, the spindle motor in which an assembled state between the inner peripheral surface of the base and the outer peripheral surface of the sleeve is improved may be provided.

According to the exemplary embodiments of the present disclosure, the adhesive is interposed between the nickel plated layers pattered in the outer peripheral surface of the sleeve and the nickel plated layers pattered in the inner peripheral surface of the base, thereby making it possible to improve the bonding strength between the sleeve and the base. That is, according to the exemplary embodiments of the present disclosure, the nickel plated layer of the sleeve and the nickel plated layer of the base may be implemented by partial peeling-off through the laser without adding a separate assembling member in order to improve the bonding strength between the sleeve and the base.

Although the embodiments of the present disclosure have been disclosed for illustrative purposes, it will be appreciated that the present disclosure is not limited thereto, and those skilled in the art will appreciate that various modifications, additions and substitutions are possible, without departing from the scope and spirit of the disclosure.

Accordingly, any and all modifications, variations or equivalent arrangements should be considered to be within the scope of the disclosure, and the detailed scope of the disclosure will be disclosed by the accompanying claims.

What is claimed is:

1. A spindle motor comprising:
a shaft;
a sleeve formed in a hollow cylindrical shape so as to rotatably support the shaft and having a plated layer coated on an outer peripheral surface thereof; and
a base including a support part having a hollow part formed at the center thereof so that the sleeve is inserted thereinto and fixed thereto and coated with a plated layer,
wherein an inner peripheral surface of the base and an outer peripheral surface of the sleeve are bonded to each other by an adhesive.

2. The spindle motor of claim 1, wherein the plated layer of the sleeve and the plated layer of the base are Ni plated layers.

3. The spindle motor of claim 1, wherein the plated layer of the sleeve has pattern forming grooves formed therein.

4. The spindle motor of claim 3, wherein the pattern forming grooves are formed along the outer peripheral surface of the sleeve.

5. The spindle motor of claim 1, wherein the plated layer of the support part of the base has pattern forming grooves formed therein.

6. The spindle motor of claim 5, wherein the pattern forming grooves are formed along an inner peripheral surface of the support part.

7. The spindle motor of claim 3, wherein the pattern forming grooves of the sleeve and the pattern forming grooves of the support part are disposed at the same height to thereby face each other.

8. An assembling method of a sleeve and a base in a spindle motor, comprising:
providing a base coated with a plated layer;
forming pattern forming grooves in the plated layer on a support part of the base;
providing a sleeve coated with a plated layer;
forming pattern forming grooves in a plated layer on an outer peripheral surface of the sleeve;
supplying an adhesive;
inserting the sleeve into the support part of the base; and
hardening the adhesive.

9. The assembling method of a sleeve and a base in a spindle motor of claim 8, wherein the pattern forming grooves of the base are formed through laser irradiation.

10. The assembling method of a sleeve and a base in a spindle motor of claim 8, wherein the pattern forming grooves of the base are formed at arithmetic average roughness of 1.5 or less.

11. The assembling method of a sleeve and a base in a spindle motor of claim 8, wherein a depth of the pattern forming groove of the base is set to a value within a range between ½ of a thickness of the plated layer before being processed and 1.1 times the thickness of the plated layer.

12. The assembling method of a sleeve and a base in a spindle motor of claim 8, wherein the pattern forming grooves of the sleeve are formed through laser irradiation.

13. The assembling method of a sleeve and a base in a spindle motor of claim 8, wherein the pattern forming grooves of the sleeve are formed at arithmetic average roughness of 1.5 or less.

14. The assembling method of a sleeve and a base in a spindle motor of claim 8, wherein a depth of the pattern forming groove of the sleeve is set to a value within a range between ½ of a thickness of the plated layer before being processed and 1.1 times the thickness of the plated layer.

15. The assembling method of a sleeve and a base in a spindle motor of claim 8, wherein the pattern forming grooves of the support part of the base and the pattern forming grooves of the sleeve are disposed so as to face each other.

16. The assembling method of a sleeve and a base in a spindle motor of claim 8, wherein the pattern forming grooves of the support part of the base are formed along an inner peripheral surface of the support part, and the pattern forming grooves of the sleeve are formed along the outer peripheral surface of the sleeve.

17. The assembling method of a sleeve and a base in a spindle motor of claim 8, wherein the spindle motor includes:
a shaft;
a sleeve formed in a hollow cylindrical shape so as to rotatably support the shaft and having a plated layer coated on an outer peripheral surface thereof and
a base including a support part having a hollow part formed at the center thereof so that the sleeve is inserted thereinto and fixed thereto and coated with a plated layer,
an inner peripheral surface of the base and the outer peripheral surface of the sleeve being bonded to each other by an adhesive.

18. The assembling method of a sleeve and a base in a spindle motor of claim 8, wherein the adhesive is a conductive adhesive.
